(19) United States
(12) Patent Application Publication
(10) Pub. No.: US 2017/0180576 A1
(43) Pub. Date: Jun. 22, 2017

(54) PRINT CONTROL APPARATUS FOR RECEIVING AND PROCESSING PRINT DATA, PRINT CONTROL METHOD, AND STORAGE MEDIUM

(71) Applicant: CANON KABUSHIKI KAISHA, Tokyo (JP)

(72) Inventor: Takeshi Kaneda, Funabashi-shi (JP)

(21) Appl. No.: 15/383,689

(22) Filed: Dec. 19, 2016

(30) Foreign Application Priority Data
Dec. 21, 2015 (JP) 2015-249068

(51) Int. Cl. H04N 1/00

(52) U.S. Cl. CPC H04N 1/00721; H04N 1/0044; H04N 1/00466; H04N 1/00639; H04N 2201/0094

(57) ABSTRACT

In various embodiments, an MFP receives print data from an information processing apparatus such as a mobile terminal or a PC, and determines an orientation of an image based on information specified in the print data, the information indicating a position of post-processing to be performed on a sheet on which an image has been printed based on the print data.

### BACKGROUND

Field

The present invention relates to a print control apparatus for receiving and processing print data, a print control method, and a storage medium.

Description of the Related Art

Conventional printing apparatuses that are connected with a network and capable of receiving print data from an information processing apparatus via the network and performing printing are known. A technique of generating print data to be transmitted to a printing apparatus by using a printer driver (or a print application) designed to use individual printing apparatuses has also been conventionally known.

In recent years, a technique of generating print data without use of a printer driver (or a print application) designed to use individual printing apparatuses has become known. For example, techniques are known for generating and transmitting print data to a printing apparatus by a general-purpose print service offered as a function of an operating system (OS) of an information processing apparatus or by a general-purpose print service offered by a print server on the Cloud. Such general-purpose print services are provided with a network protocol for causing a printing apparatus to perform printing. The general-purpose print services communicate with a printing apparatus according to the protocol to achieve printing.

Print servers and information processing apparatuses offering general-purpose print services are desired to support various types of printing apparatuses. In this regard, it is known that a general-purpose print service can manage configuration information of printing apparatuses in order to support functions and specifications that vary among printing apparatuses. For example, in the technique discussed in Japanese Patent Application Laid-Open No. 2013-187571, a print server generates a user interface to allow a user, at the time of printing, to set print properties based on configuration information of a managed printing apparatus and offers a function of tracking a print job until printing is completed.

Further, it is known that, when a printing apparatus performs post-processing on sheets, the printing apparatus can perform binding processing and punching at positions specified by the user.

When generating print data by a general-purpose print service, the print data can be generated based on configuration information of a printing apparatus. In this case, when a vendor offering each service is different from a device vendor offering a printing apparatus, print data in which all of the print properties required for the printing apparatus are correctly described may not be generated.

More specifically, the generated print data may not include information indicating the orientation of an image, for example. Thus, when performing processing (for example, print data previewing) which requires determination of the orientation of an image in print data, it is possible the preview image may be displayed in an orientation that is different from an orientation intended by the user.

### SUMMARY

Various embodiments of the present disclosure are directed to a print control apparatus, a print control method, and a storage medium that are capable of suitably determining an image property that is not included in print data.

According to an aspect of the present disclosure, a print control apparatus includes a memory device that stores a set of instructions, and at least one processor that executes the instructions for performing operations comprising: receiving print data transmitted from an information processing apparatus; and determining an orientation of an image in the print data based on information specified in the print data, the information indicating a position of post-processing to be performed on a sheet on which an image has been printed based on the print data.

Further features will become apparent from the following description of exemplary embodiments with reference to the attached drawings.

### BRIEF DESCRIPTION OF THE DRAWINGS

FIG. 1 is a diagram illustrating a configuration of a printing system according to one embodiment.

FIG. 2 is a block diagram illustrating a hardware configuration of a multifunction peripheral (MFP) according to one embodiment.

FIG. 3 is a diagram illustrating communication between the MFP and an information processing apparatus according to one embodiment.

FIG. 4 illustrates an example of configuration information transmitted from the MFP to the information processing apparatus according to one embodiment.

FIGS. 5A and 5B illustrate examples of print data received by the MFP according to one embodiment.

FIG. 6 is a cross-sectional view of a sheet processing unit according to one embodiment.

FIG. 7 is a diagram illustrating an example of a screen displayed on an operation unit according to one embodiment.

FIGS. 8A, 8B, 8C, and 8D are diagrams illustrating examples of screens displayed on the operation unit according to one embodiment.

FIG. 9 is a diagram illustrating determination of an image orientation based on binding processing settings according to one embodiment.

FIG. 10 is a flowchart illustrating print control according to an exemplary embodiment.

FIG. 11 is a flowchart illustrating print control according to an exemplary embodiment.

FIG. 12 is a flowchart illustrating print control according to an exemplary embodiment.

FIG. 13 is a condition table according to an exemplary embodiment.

FIG. 14 is a diagram illustrating determination of an image orientation and determination of a binding edge based on binding processing settings according to one embodiment.

FIG. 15 is a diagram illustrating determination of a punching position based on binding processing settings according to one embodiment.

FIG. 16 is a flowchart illustrating print control according to an exemplary embodiment.

FIG. 17 is a flowchart illustrating print control according to an exemplary embodiment.

FIGS. 18A and 18B are condition tables according to an exemplary embodiment.

### DESCRIPTION OF THE EMBODIMENTS

Exemplary embodiments will be described in detail below with reference to the accompanying drawings. While exemplary embodiments have been described, it is to be understood that the ambit of the appended claims does not limit the invention. In addition, not all of the combinations of the features described in the exemplary embodiments are indispensable to the solutions presented in the present disclosure.

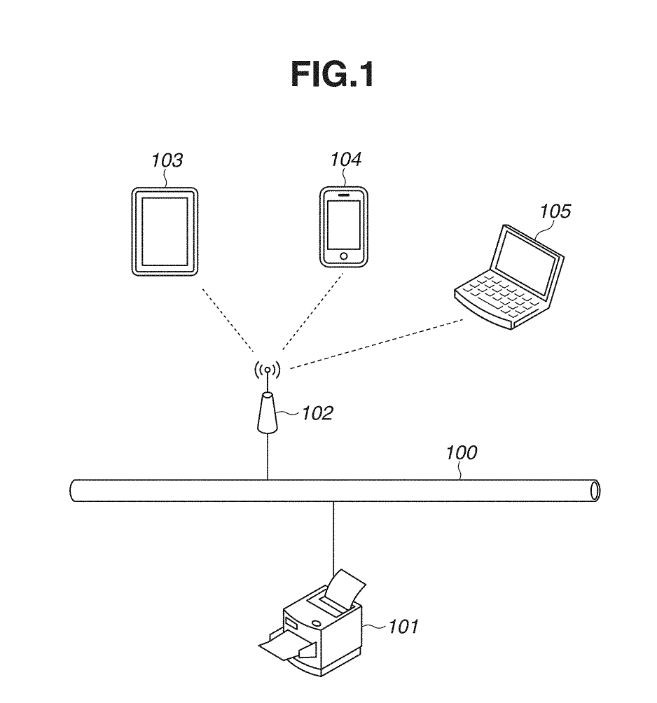

FIG. 1 is a diagram illustrating a configuration of a printing system according to a first exemplary embodiment. A multifunction peripheral (MFP) 101 and an access point (AP) 102 are connected to a local area network (LAN) 100 so that they can communicate with each other. The MFP 101 will be described below as an example of a printing apparatus according to the present exemplary embodiment. Mobile terminals 103 and 104 and a personal computer (PC) 105 will be described below as examples of information processing apparatuses. Information processing apparatuses such as the mobile terminals 103 and 104 and the PC 105 can communicate with the MFP 101 on the network (LAN 100) via the AP 102. The PC 105 may be connected to the LAN 100 via a LAN cable. In the present exemplary embodiment, the above-described configuration will be described below as an example of the configuration of the printing system. However, the configuration of the printing system is not limited thereto. At least one information processing apparatus and a printing apparatus need to be connected via a network in such a manner that they can communicate with each other.

First, the MFP 101 will be described below. The MFP 101 has a reading function of reading an image on an original document and a printing function of printing an image on a sheet. The MFP 101 can perform print processing based on print data received via a network.

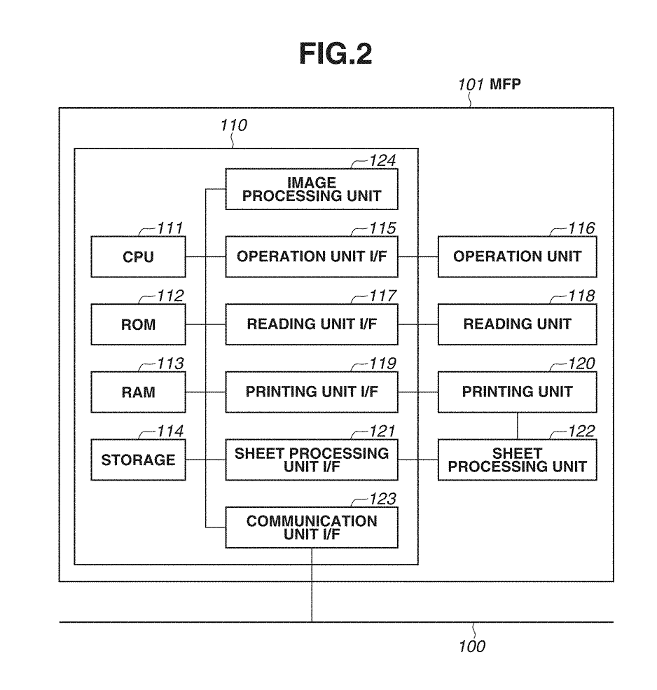

FIG. 2 is a block diagram illustrating a hardware configuration of the MFP 101. The MFP 101 has the reading function of reading an image on an original document and the printing function of printing an image on a sheet. In addition, the MFP 101 has a file transmission function of transmitting an image to an external information processing apparatus.

In the present exemplary embodiment, the MFP 101 is described as an example of the printing apparatus. However, the printing apparatus is not limited thereto. For example, the printing apparatus may be a Single Function Peripheral (SFP) that does not have a reading function.

A control unit 110 including a central processing unit (CPU) 111 controls overall operations of the MFP 101. The CPU 111 reads a control program stored in a read only memory (ROM) 112 or a storage 114 and performs various control such as print control and reading control. The ROM 112 stores control programs executable by the CPU 111. A random access memory (RAM) 113 is the main memory of the CPU 111 and is used as a work area or a temporary storage area for loading thereon various control programs. The storage 114 stores print data, image data, various programs, and various setting information. In the present exemplary embodiment, an auxiliary storage unit such as a hard disk drive (HDD) is used as the storage 114. However, a nonvolatile memory such as a solid state drive (SDD) may be used instead of an HDD.

Further, in the MFP 101 according to the present exemplary embodiment, one CPU 111 implements processing illustrated in the flowcharts described below by using one memory (RAM 113). However, other configurations are also applicable. For example, processing illustrated in the flowcharts described below can be implemented by collaboratively operating a plurality of CPUs, RAMs, ROMs, and storages. In addition, a part of processing may be implemented by using a hardware circuit such as an Application Specific Integrated Circuit (ASIC) or a Field-Programmable Gate Array (FPGA).

An operation unit interface (I/F) 115 connects an operation unit 116 and the control unit 110. The operation unit 116 is provided with a liquid crystal display (LCD) unit having a touch-panel function, and various hardware keys. The operation unit 116 functions as a display unit for displaying information and as a receiving unit for receiving user instructions.

A reading unit I/F 117 connects a reading unit 118 and the control unit 110. The reading unit 118 reads an original document and generates a read image. The generated read image is stored in the storage 114 or the RAM 113. The read image generated by the reading unit 118 is transmitted to an information processing apparatus or used for image printing on a sheet.

A printing unit I/F 119 connects a printing unit 120 and the control unit 110. A printing image generated by analyzing print data is transmitted from the control unit 110 to the printing unit 120 via the printing unit I/F 119. The printing unit 120 receives a control command and a print target image via the control unit 110 and, based on the image, prints an image on a sheet fed from a sheet feeding cassette (not illustrated). The printing method of the printing unit 120 may be the electrophotographic method or the ink-jet method. Other printing methods such as the heat transfer method are also applicable.

The control unit 110 is connected to the LAN 100 via a communication unit I/F 123. The communication unit I/F 123 transmits an image and information to an information processing apparatus on the LAN 100 and receives print data and information from an information processing apparatus on the LAN 100.

According to the present exemplary embodiment, the print data received from an information processing apparatus can be once reserved in the storage 114. The user can select the reserved print data by operating the operation unit 116 of the MFP 101 and printing can be performed based on the selected print data (hereinafter referred to as reservation printing).

An image processing unit 124 has a raster image processor (RIP) function of rasterizing the print data received via a network and generating an image to be used for printing. The image processing unit 124 can also perform resolution conversion and correction processing on an image obtained by rasterizing the print data. In the present exemplary embodiment, the image processing unit 124 is implemented by a hardware circuit (such as an ASIC and an FPGA). However, the image processing unit 124 is not limited thereto. For example, the MFP 101 may further include a processor for image processing, and image processing and print data rasterization processing may be implemented by the processor for image processing executing an image processing program. In this case, the processor for image processing and the CPU 111 collaboratively operate to implement the processing illustrated in the flowcharts described below. Further, the CPU 111 may perform image processing and print data rasterization processing by executing a program for performing image processing. Image processing may be performed by the combination of the above-described configurations.

A sheet processing unit I/F 121 connects a sheet processing unit 122 and the control unit 110. The sheet processing unit 122 receives a control command from the CPU 111 and, according to the control command, performs post-processing on sheets printed by the printing unit 120. For example, the sheet processing unit 122 performs post-processing such as aligning a plurality of sheets, opening punch holes on each sheet, and binding a plurality of sheets. Post-processing functions and capabilities provided by the sheet processing unit 122 are notified to the control unit 110 via the sheet processing unit I/F 121 in advance (for example, at the time of the activation of the MFP 101) and stored in the storage 114 or the RAM 113.

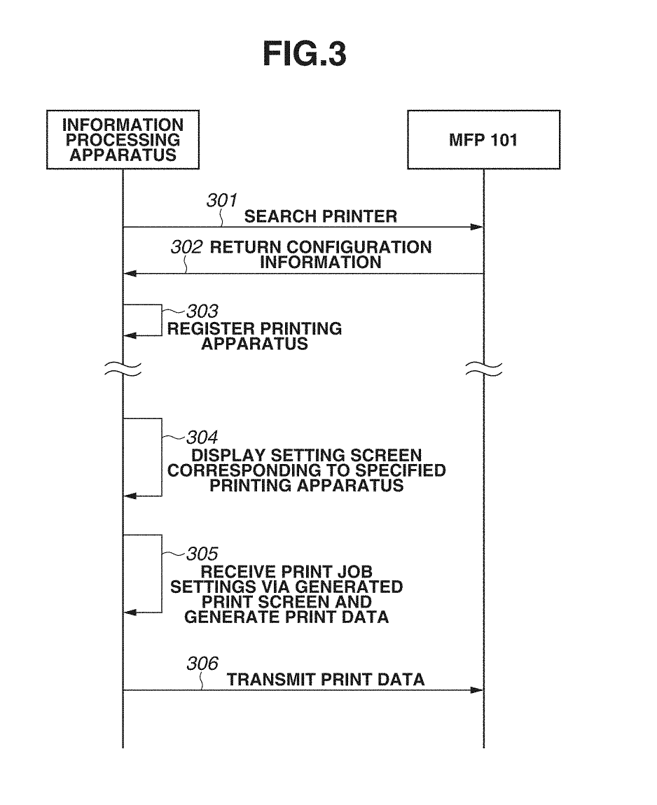

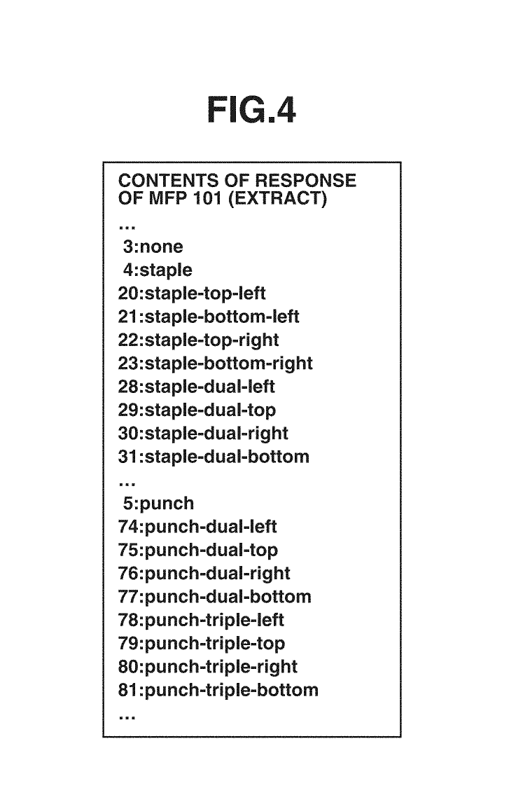

Information exchange between an information processing apparatus and the MFP 101 will be described below with reference to FIG. 3. FIG. 3 is a diagram illustrating a series of sequences performed when the MFP 101 receives print data from an information processing apparatus. In step 301, the information processing apparatus such as the mobile terminals 103 and 104, and the PC 105 broadcasts a packet for searching for a printer on the LAN 100. Upon reception of the packet for searching for a printing apparatus, then in step 302, the MFP 101 returns configuration information (also referred to as device information) included in the MFP 101 to the information processing apparatus which transmitted the packet. This configuration information is, for example, described with text data. The text data in the configuration information predefines a keyword indicating the capabilities of each individual printing apparatus. As specific configuration information is described as a list of functions supported by the MFP 101, such as the supported paper sizes, the presence or absence of a two-sided print function, the presence of absence of an Nup function, executable types of post-processing functions that can be performed, and positions where post-processing positions can be performed. In step 303, the information processing apparatus registers the MFP's device information regarding the supported paper sizes, the presence or absence of a two-sided printing, the presence or absence of an Nup function, executable post-processing functions, etc. by using the keyword described in the received text data. FIG. 4 illustrates a part of the configuration information returned from the MFP 101 to the information processing apparatus, i.e., an extract of the configuration information regarding the post-processing. The MFP 101 notifies, in the form of text data, the information processing apparatus of the capabilities of outputting printed sheets without performing post-processing (“3:none”), outputting printed sheets after binding them, and forming punch holes on a sheet. The MFP 101 also notifies, in the form of text data, the information processing apparatus of detailed setting of each post-processing function.

Print properties of the post-processing without an explicit specification of a position on sheets where the post-processing is to be performed as described in the lines 4 and 5 illustrated in FIG. 4, are referred to as “binding processing settings without a position specification”. Print properties of the post-processing with an explicit specification of a position on sheets where the post-processing is to be performed as described in the lines 20 to 31 and 74 to 81 illustrated in FIG. 4, are referred to as “binding processing settings with a position specification”.

According to the present exemplary embodiment, the sheet processing unit 122 of the MFP 101 is assumed to be capable of binding printed sheets at one corner position or two positions on one side of printed sheets. Therefore, the MFP 101 notifies the information processing apparatus of at least lines 20 to 23 and 28 to 31 illustrated in FIG. 4 as information of executable binding processing. The sheet processing unit 122 is assumed to be capable of forming two or three punch holes on one side of a printed sheet. Therefore, the MFP 101 notifies the information processing apparatus of at least lines 5 and 74 to 81 illustrated in FIG. 4 as executable punching.

The user can request a printing apparatus registered in prior registration processing in steps 301 to 303. Upon reception of a specification of a printing apparatus to be used for printing through a user operation, a print service provided by the information processing apparatus refers to the device information corresponding to the printing apparatus specified by the user. In step 304, the information processing apparatus displays a setting screen for setting print properties based on the referenced device information on an operation unit (not illustrated) of the information processing apparatus. The user sets print properties via the setting screen. In step 305, upon reception of an instruction for starting printing via the setting screen, the information processing apparatus generates print data. In step 306, the information processing apparatus transmits the generated print data to the MFP 101.

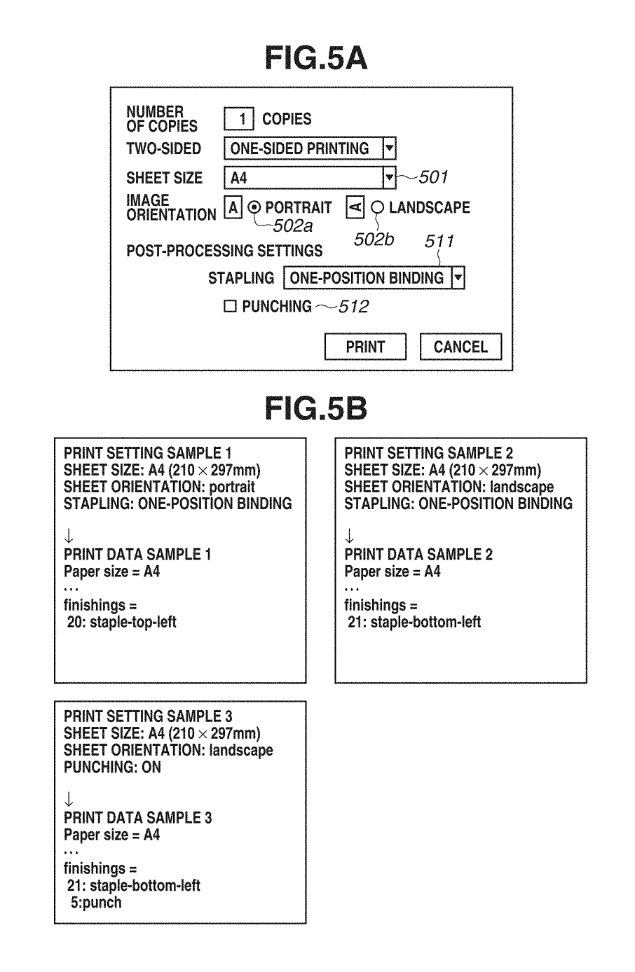

Setting of print properties and generation of print data in the information processing apparatus will be described below with reference to FIGS. 5A and 5B. FIG. 5A illustrates an example of a setting screen for setting print properties. The user can set a sheet size to be used for printing by selecting an item 501 illustrated in FIG. 5A. The user can also set the orientation of the print target image on a sheet by selecting a Portrait button 502a or a Landscape button 502b.

The user can also make setting for binding printed sheets by selecting an item 511 illustrated in FIG. 5A. When the item 511 is selected, a drop down list (not illustrated) is displayed allowing the user to select “One-Position Binding”, “Two-Position Binding”, or “None” from the drop down list. When the item “One-Position Binding” is selected, sheets are to be bound at any one of the four corners (top left, bottom left, top right, and bottom right) thereof. When the item “Two-Position Binding” is selected, sheets are to be bound at two positions on a side thereof. Depending on the capabilities of the MFP 101, the user may select a setting for binding sheets at three positions on a side thereof. The user can set whether to perform punching on printed sheets by selecting a Punching check box 512 illustrated in FIG. 5A.

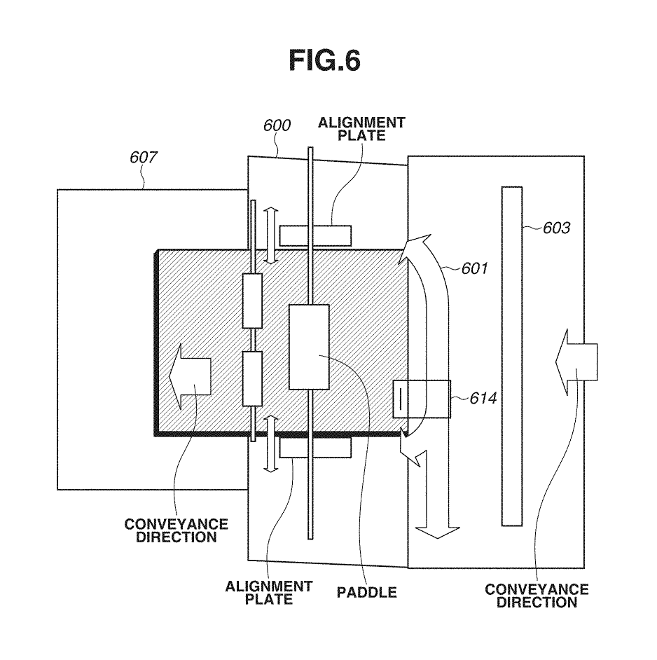

Meanwhile, to perform post-processing at a suitable position via the sheet processing unit 122, the MFP 101 performs post-processing at a specified position by rotating the orientation of sheet conveyance and the orientation of image printing. These pieces of processing will be described below with reference to FIG. 6.

FIG. 6 is a cross-sectional view of the sheet processing unit 122 when viewed from above. Binding processing and punching will be described with reference to FIG. 6. A puncher 603 for performing punching can perform punching on a sheet, with an image printed thereon by the printing unit 120, while the sheet is being conveyed to an output tray 607. According to the present exemplary embodiment, the puncher 603 performs punching on the trailing end side of the conveyed sheet. Therefore, after vertically inverting the image orientation (180-degree rotation), the puncher 603 is able to perform punching at two positions on the side perpendicularly intersecting with the conveyance direction. The combination of the conveyance orientation of a sheet used for printing and the image rotation enables forming punch holes at the top, bottom, left, or right side of the sheet. The conveyance orientation of a sheet refers to Long Edge Feed (LEF) orientation or Short Edge Feed (SEF) orientation in which the sheet is conveyed. A binding unit 614 for performing binding processing can bind a plurality of sheets held in an intermediate tray 600. To enable holding a plurality of sheets, the intermediate tray 600 is inclined by positioning the downstream side in the sheet discharge direction (left side of FIG. 6) upwardly in the vertical direction and positioning the upstream side in the sheet discharge direction (right side of FIG. 6) downwardly in the vertical direction.

The binding unit 614 is configured to be slid by a motor (not illustrated) as indicated by the arrow 601 illustrated in FIG. 6. The CPU 111 drives a motor (not illustrated) to move the binding unit 614 in the direction perpendicularly intersecting with the sheet conveyance direction and bind a sheet bundle at a corner on the trailing end side in the sheet conveyance direction or at two positions on the trailing end side. Therefore, after moving the binding unit 614 and vertically inverting the image orientation (180-degree rotation), the sheet bundle can be bound at two positions on the side perpendicularly intersecting with the sheet conveyance direction. Similarly, printed sheets can be bound at any one of the four corners (top left, top right, bottom right, and bottom left). Sheets that have undergone punching and binding processing as required by the sheet processing unit 122 are output onto the output tray 607.

Print data generated by a general-purpose print service provided by the information processing apparatus will be described below. The print properties of the print data generated by a general-purpose print service are not necessarily easy to process for the printing apparatus. For example, print data in which all the print properties required for the printing apparatus are correctly described may not be generated. More specifically, the property (hereinafter referred to as image orientation) regarding which direction of an image in the print data should be regarded as the upward direction (i.e., which direction should be regarded as the top of the print product) and the property regarding the way of opening (way of binding) an original document.

A specific example will be described below with reference to FIG. 5B. A print data sample 1 is an example of print data generated when a setting (hereinafter referred to as a print setting sample 1) is made, via the setting screen, to print a portrait image on A4 sheets and bind the printed sheets at one position thereon. As illustrated in the screen illustrated in FIG. 5A, the general-purpose print service according to the present exemplary embodiment receives a specification of one-position binding but does not explicitly receive the binding position where the binding processing is to be performed. However, when generating print data, the binding position where the binding processing is to be performed is set as indicated by each print data sample illustrated in FIG. 5B. Actually, when one-position binding is specified, there is a plurality of binding position candidates (top left, top right, bottom right, and bottom left). In this case, it is considered that the general-purpose print service according to the present exemplary embodiment generates print data on the assumption that sheets should be bound at the top left corner when the top of the image is upwardly positioned.

Thus, in this case, printing on A4 size (210×297) sheets and binding at the top left corner of sheets are set as print properties of the print data. On the other hand, the image orientation was lost at the time of print data generation.

A print data sample 2 is an example of print data generated when a setting (hereinafter referred to as a print setting sample 2) is made, via the setting screen, to print a landscape image on A4 size (210×297) sheets and bind the printed sheets at one position thereon. In this case, printing on A4 size (210×297) sheets and binding at the bottom right corner of sheets are set as print properties of the print data. In this case, it is considered that sheet-based binding properties are set based on a setting of printing a landscape image on A4 size (210×297) sheets on the assumption that, when one-position binding is received, sheets should be bound at the top left corner when the top of the image is upwardly positioned. Therefore, a property of binding at the bottom left corner as a sheet-based binding position is set. On the other hand, similar to the print data sample 1, the image orientation was lost at the time of print data generation.

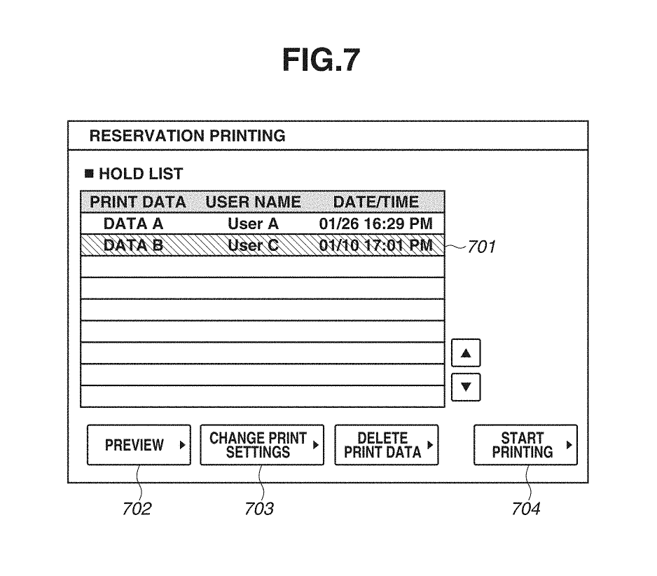

A problem arises when the image orientation property is not set in the print data. As described above, the MFP 101 according to the present exemplary embodiment can perform reservation printing. FIG. 7 is a diagram illustrating an example of an operation screen displayed on the operation unit 116 by the CPU 111. This operation screen is used to set the processing to be performed on the reserved print data. Referring to the screen illustrated in FIG. 7, data B in a line 701 is selected. The data B is print data received from the information processing apparatus and then reserved in the storage 114. The data B is equivalent to the print data sample 2 illustrated in FIG. 5B. Via the screen illustrated in FIG. 7, the user can select a piece of print data reserved in the storage 114 and then select the processing to be performed on the print data.

A Preview button 702 is selected to use the preview function. The preview function is a function of displaying an image based on the print data on the operation unit 116 to allow the user to confirm it. A Change Print Settings button 703 is used to change the print data settings. The present exemplary embodiment will be described below centering on a process for changing the position where the binding processing is to be performed and on a process for combining the printing date and stamp with the print data and then printing an image, as examples of print settings that can be changed by the Change Print Settings button 703.

A Start Printing button 704 is used to start printing based on the print data selected via the screen illustrated in FIG. 7.

In this case, if print data without an image orientation property setting or print data without a correct image orientation property setting is reserved, the user's convenience may possibly be degraded.

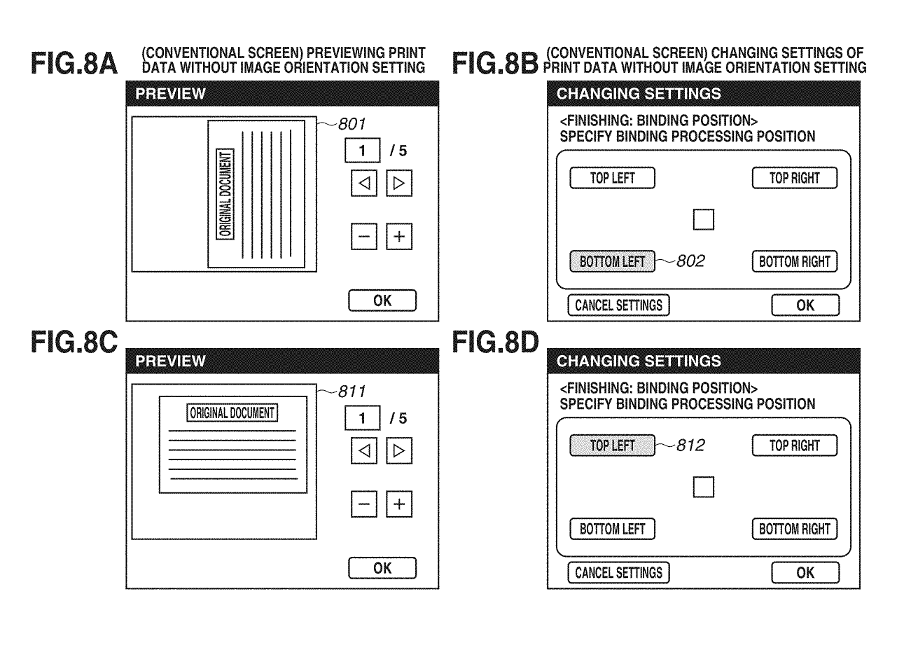

As a specific example, the above-described preview function will be described below. FIGS. 8A, 8B, 8C, and 8D are diagrams illustrating examples of operation screens displayed on the operation unit 116 by the CPU 111. FIG. 8A illustrates an example of a screen displayed by the preview function, i.e., an example of a conventional preview screen displayed based on print data without an image orientation property setting. In this case, FIG. 8A illustrates an example of a preview screen based on the data B (i.e., the print data sample 2) reserved in the storage 114.

When the user previews print data, it is desirable that an image is displayed so that the top of the image is upwardly positioned. For example, when previewing an image printed based on the print setting sample 2 illustrated in FIG. 5B, it is desirable that the image is displayed so that the top of the image is upwardly positioned as with a preview image 811 illustrated in FIG. 8C. Therefore, the preview function rotates the preview image to be displayed in the preview screen according to the orientation property included in the print data so that the top of the image is upwardly positioned.

However, in the case of print data without an image orientation property setting as with the print data sample 2 illustrated in FIG. 5B, the image orientation is not known. In such a case, the preview function generates a preview image (a preview image 801 illustrated in FIG. 8A) on the assumption that the image orientation is the default orientation (more specifically, the upper side of the image included in the print data is the top of the image). In this case, a problem that the preview image is hard to view since the top of the image is not upwardly positioned.

The image orientation may become important also when changing print settings. More specifically, there may be a case where the post-processing settings are changed. FIG. 8B illustrates an example of a screen for changing the print settings afterwards, i.e., an example of a screen for changing the position on a print product where the binding processing is to be performed. In this case, when the user changes the post-processing settings, it is desirable for the user to set the post-processing with reference to the top of the image. For example, when changing print data binding settings based on the print setting sample 2 illustrated in FIG. 5B, it is desirable for the user to be able to set and change the binding position with reference to the top of the image as indicated by a button 812 illustrated in FIG. 8D. Therefore, the preview function converts the sheet-based binding position stored in the print data into a position based on the top of the image, allowing the user to change the position where the post-processing is to be performed.

However, when the image orientation property is not set as with the print data sample 2 illustrated in FIG. 5B, the orientation is not known. In such a case, the user will set the binding processing position on the assumption that the image orientation is the default orientation (more specifically, the upper side of the image included in the print data is the top of the image). Therefore, the user who entered the print data sample 2 is unable to set the post-processing based on the top of the image, and therefore will find the situation inconvenient.

Further, when printing an image by combining a character string or pattern such as the date of printing, “SECRET”, and “CONFIDENTIAL” with the print data, it is necessary to combine the target character string or pattern according to the image orientation. However, if the actual image orientation is not known as with the print data sample 2, the preview function will combine a character string or pattern with the print data on the assumption that the image orientation is the default orientation (more specifically, the upper side of the image included in the print data is the top of the image). Therefore, the orientation of the character string or pattern supplied afterwards differs from the orientation of the print target image, possibly resulting in a print product not intended by the user.

As described above, if the image orientation property is not set, the user's convenience may be hampered when the MFP 101 provides the user with a function.

In view of these problems, the present exemplary embodiment will be described below centering on a process for determining the image orientation based on the post-processing settings with a position specification when the print data includes the post-processing settings with a sheet-based position specification.

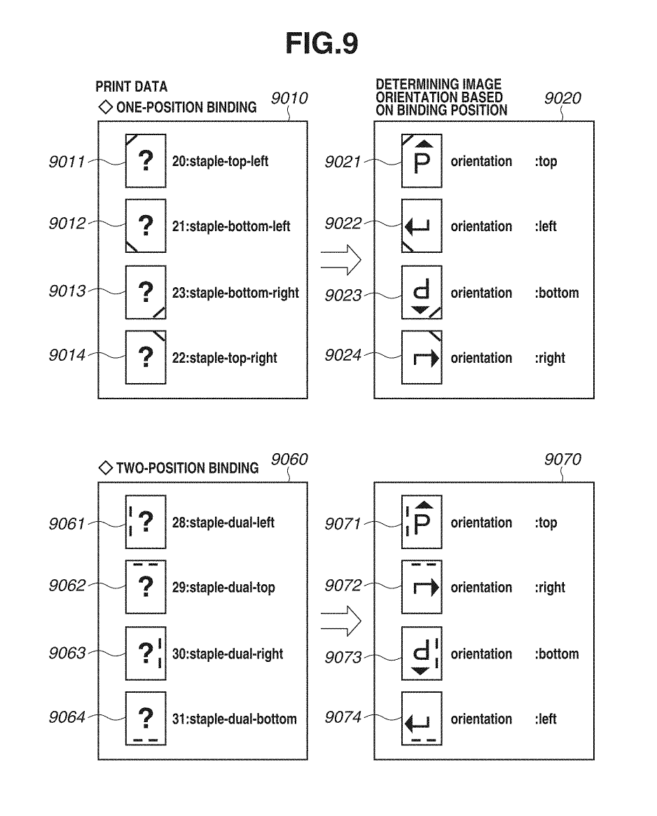

FIG. 9 is a diagram illustrating an example of processing for determining the image orientation. With reference to FIG. 9, descriptions will be made of a process for determining the image orientation based on the print properties of the binding processing with a position specification as an example of a post-processing setting with a position specification.

First, the following describes a process for determining the image orientation when binding at any one corner of sheets is specified as a print property of the binding processing (a group 9010).

As indicated by a setting 9011, when binding at the top left corner of sheets is specified, the CPU 111 determines that the top of the image is upwardly positioned as indicated by a setting 9021. When binding at the bottom left corner of sheets is specified as indicated by a setting 9012, the CPU 111 determines that the top of the image is leftwardly positioned as indicated by a setting 9022.

In the print data by the general-purpose print service assumed with reference to FIG. 5B, a portrait image is arranged so that the top of the image is upwardly positioned, and a landscape image is arranged so that the top of the image is leftwardly positioned. Therefore, in the above-described assumption, neither a setting 9013 nor 9014 is specified in the binding settings. However, there may be generated print data for arranging a portrait image so that the top of the image is downwardly positioned and arranging a landscape image so that the top of the image is rightwardly positioned. Assuming print data for arranging an image in such orientations, when binding at the top right or the bottom right corner of sheets is specified, the CPU 111 will determine the image orientation as follows.

In this case, when binding at the bottom right corner of sheets is specified as indicated by a setting 9013, the CPU 111 determines that the top of the image is downwardly positioned as indicated by a setting 9023. When binding at the top right corner of sheets is specified as indicated by a setting 9014, the CPU 111 determines that the top of the image is rightwardly positioned as indicated by a setting 9024.

The following describes a process for determining the image orientation when binding at two positions on one side of sheets is specified as a print property of the binding processing (a group 9060). When binding at two positions on the left side of sheets is specified as indicated by a setting 9061, the CPU 111 determines that the top of the image is upwardly positioned as indicated by a setting 9071. When binding at two positions on the bottom side of sheets is specified as indicated by a setting 9064, the CPU 111 determines that the top of the image is leftwardly positioned as indicated by a setting 9074.

In the print data by the general-purpose print service assumed with reference to FIG. 5B, neither a setting 9062 nor 9063 is specified in the binding setting. However, there may be generated print data for arranging a portrait image so that the top of the image is downwardly positioned and arranging a landscape image so that the top of the image is rightwardly positioned. Assuming print data for arranging an image in such orientations, when binding at two positions on the top or the right side of sheets is specified, the CPU 111 determines the image orientation as follows. In this case, when binding at two positions on the top side of sheets is specified as indicated by a setting 9062, the CPU 111 determines that the top of the image is rightwardly positioned as indicated by a setting 9072. When binding at two positions on the right side of sheets is specified as indicated by a setting 9063, the CPU 111 determines that the top of the image is downwardly positioned as indicated by a setting 9073.

When the post-processing for binding at two positions on sheets is specified in this way, the CPU 111 determines the image orientation included in the print data on the assumption that the binding positions are specified based on the view of binding at the left edge (left side of the image) when the top of the image is upwardly positioned.

When the print data includes the post-processing settings with a sheet-based position specification based on the view of determining the image orientation illustrated in FIG. 9, the CPU 111 can determine the image orientation based on the post-processing settings with a sheet-based position specification.

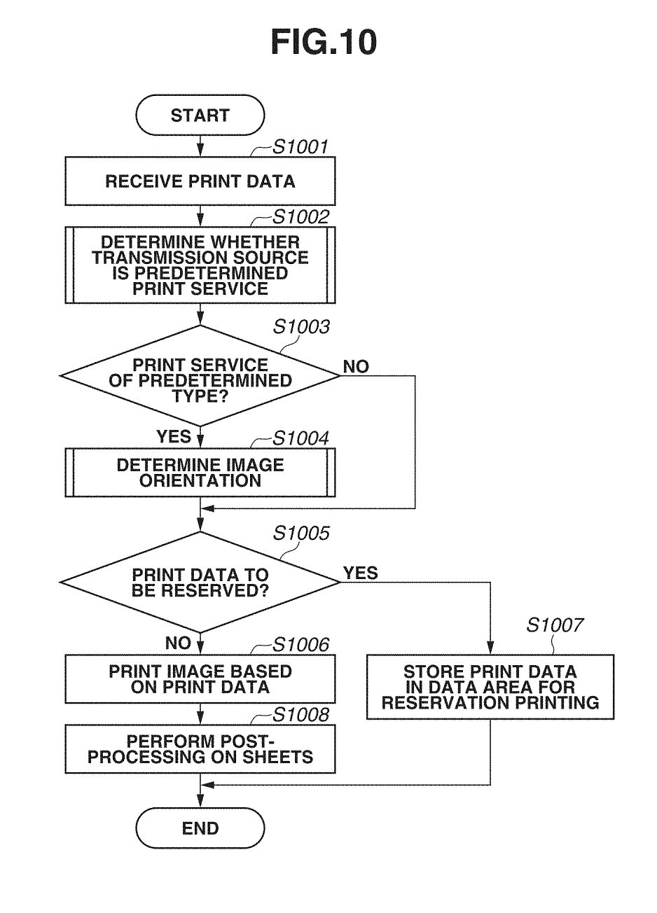

The following describes a process for determining the image orientation when the MFP 101 receives print data and then applies the determined image orientation to the print data, with reference to the flowcharts illustrated in FIGS. 10 to 12.

Each operation (step) illustrated in the flowcharts illustrated in FIGS. 10 to 12 is implemented when the CPU 111 of the MFP 101 executes a control program stored in the ROM 112 or the storage 114.

According to the present exemplary embodiment, an information processing apparatus such as a PC and a mobile terminal transmits print data to the MFP 101 via the LAN 100. When the information processing apparatus transmits print data to the MFP 101, the information processing apparatus uses various printing protocols such as the Internet Printing Protocol (IPP) and the Line Printer Daemon protocol (LPR).

When the IPP is used as a printing protocol and when the print data format is PWG-RASTER, the present exemplary embodiment assumes that the image orientation property may not be included in the print data or the image orientation included therein may not be correct. When the LPR is used as a printing protocol, the present exemplary embodiment also assumes that the image orientation property is highly likely to be correctly set.

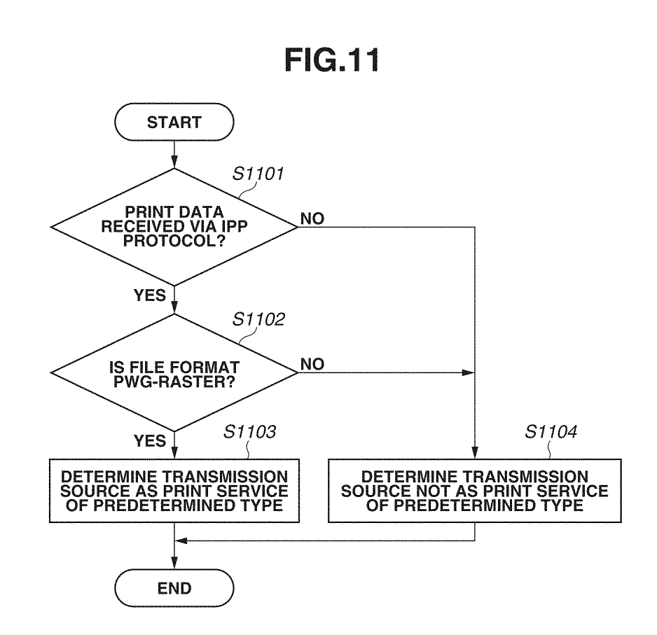

In step S1001, the CPU 111 receives print data from an information processing apparatus. In step S1002, the CPU 111 determines whether the generation source of the print data received in step S1001 is a print service of a predetermined type. Specific control processing will be described below with reference to the flowchart illustrated in FIG. 11.

In step S1101, the CPU 111 determines whether the printing protocol used to receive print data is the IPP. The CPU 111 determines the printing protocol, for example, based on the reception port number. When the printing protocol for the received print data is the IPP (YES in step S1101), the processing proceeds to step S1102. On the other hand, when the printing protocol for the received print data is not the IPP (NO in step S1101), the processing proceeds to step S1104.

In step S1102, the CPU 111 determines whether the format of the received print data is PWG-RASTER. The CPU 111 determines the format, for example, by analyzing the header information included in the print data. When the CPU 111 determines that the print data format is PWG-RASTER (YES in step S1102), the processing proceeds to step S1103. On the other hand, when the CPU 111 determines that the print data format is not PWG-RASTER (NO in step S1102), the processing proceeds to step S1104. In step S1103, the CPU 111 determines that the transmission source print service is a print service of a predetermined type.

In step S1104, the CPU 111 determines that the transmission source print service is not a print service of a predetermined type.

Although, in the present exemplary embodiment, the format information and printing protocol type are used to determine whether the print data generation source is a print service of a predetermined type, the determination method is not limited thereto. For example, the CPU 111 may determine whether the print data generation source is a print service of a predetermined type based on the User-agent information included in the HTTP request when the information processing apparatus transmits the print data to the MFP 101. Further, the CPU 111 may determine that the print data generation source is a print service of a predetermined type when the print data generation source is a specific print service of a specific version based on the User-agent information.

Returning to the description of FIG. 10, as a result of the determination in step S1002, when the CPU 111 determines that the print data generation source is a print service of a predetermined type (YES in step S1003), the processing proceeds to step S1004. On the other hand, when the CPU 111 determines that the print data generation source is not a print service of a predetermined type (NO in step S1003), the processing proceeds to step S1005.

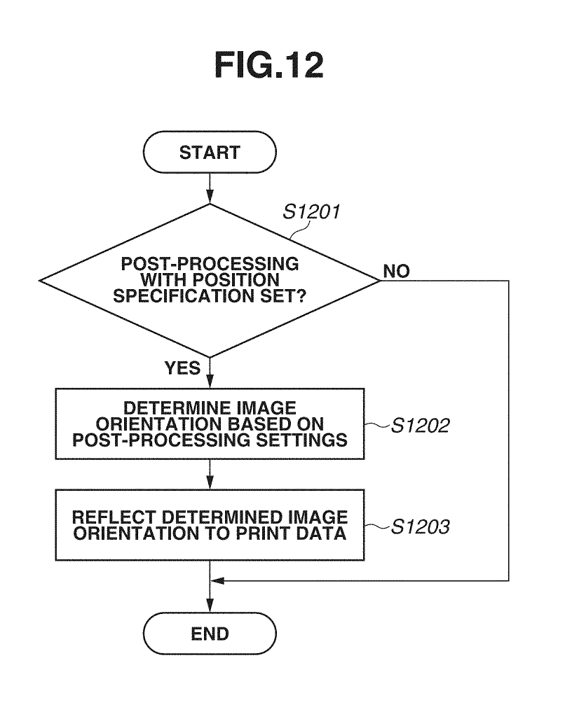

In step S1004, the CPU 111 determines the image orientation. Specific control processing will be described below with reference to the flowchart illustrated in FIG. 12. In step S1201, the CPU 111 determines whether the post-processing with a position specification is set. More specifically, when the print data includes the binding processing settings with a binding position specification as described in lines 20 to 23 and 28 to 31 illustrated in FIG. 4, the CPU 111 determines that the post-processing with a position specification is set (YES in step S1201), and the processing proceeds to step S1002. On the other hand, when the print data includes the binding processing settings without a position specification or when the print data does not include the binding processing settings, the CPU 111 does not determine the image orientation (NO in step S1201), and the processing proceeds to step S1005. When the CPU 111 does not determine the image orientation, the CPU 111 will perform print processing assuming that the image orientation is the default orientation (for example, the upper side of the image is the top of the image).

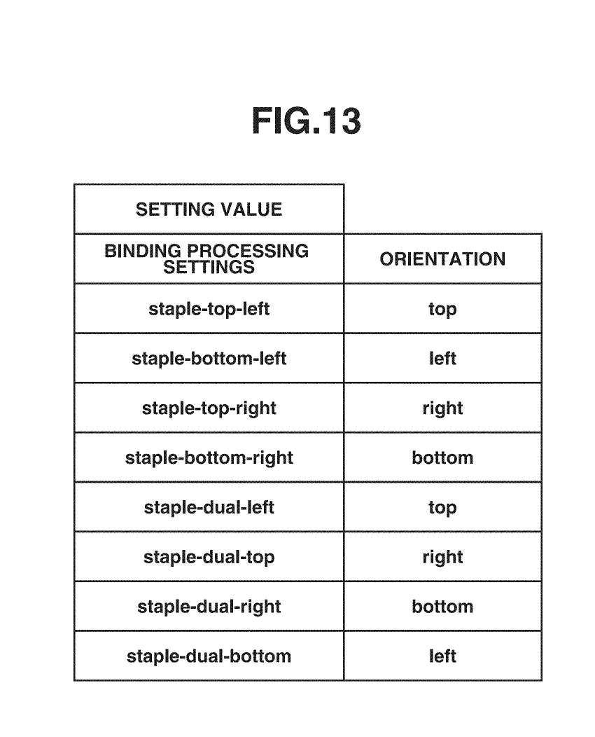

In step S1202, the CPU 111 determines the image orientation based on the post-processing settings. First, the CPU 111 acquires post-processing setting values included in the print data. Then, the CPU 111 performs a search in condition tables stored in the storage 114 using the acquired post-processing settings as a search condition to determine the image orientation. FIG. 13 is an example of a condition table stored in the storage 114, which is used to determine the image orientation. Although, in the present exemplary embodiment, the image orientation is determined based on the post-processing setting values with a position specification using the condition tables, the determination method is not limited thereto. For example, the CPU 111 may determine the image orientation by executing a determination program describing conditional branches for determining the image orientation described above with reference to FIGS. 8A, 8B, 8C, and 8D.

In step S1203, the CPU 111 applies the image orientation determined in step S1202 to the print data, and the processing proceeds to step S1005.

Returning to the description of FIG. 10, in step S1005, the CPU 111 determines whether the print data is to be reserved. In this case, when the reservation of the received print data as operation settings for receiving the print data is set in the MFP 101 or when reservation printing is set as a print data property, the CPU 111 determines that the print data is to be reserved (YES in step S1005), and the processing proceeds to step S1007. On the other hand, when the reservation of the received print data is set to OFF and reservation printing is not set as a print data property, the CPU 111 determines that the print data is not to be reserved (NO in step S1005), and the processing proceeds to step S1006.

In step S1007, the CPU 111 stores the print data in the data area for storing print data for reservation printing. When the CPU 111 determines the image orientation through a series of processing in step S1004, the print data to which the image orientation is reflected will be reserved.

In step S1006, the CPU 111 prints an image on a sheet based on the print data. The CPU 111 prints an image on a sheet by combining the conveyance orientation of the sheet used for printing and the rotation of the image. In step S1008, the CPU 111 performs the post-processing on the printed sheet in collaboration with the sheet processing unit 122. Upon completion of the print processing, the CPU 111 ends a series of processing.

Although, in the present exemplary embodiment, the post-processing with an explicit position specification on sheets is described as an example of binding processing with a position specification, the post-processing is not limited thereto. For example, the present exemplary embodiment is also applicable to a case of determining the image orientation based on the punching settings with a punching position specification on a sheet or on the folding processing settings with a folding position specification on a sheet.

Although, in the present exemplary embodiment, the MFP 101 having the printing unit 120 is described as an example of a print control apparatus, a print control apparatus is not limited thereto. The present exemplary embodiment is also applicable to a print server for transmitting the print data to a printing apparatus, for example.

In this case, the print server receives the print data from the information processing apparatus and performs the processing in steps S1001 to S1004 on the received print data. Instead of the processing in step S1005 and subsequent steps, the CPU 111 needs to transmit the print data obtained in step S1004 to the printing apparatus. In this case, the print data received from the information processing apparatus will be converted into print data with an image orientation setting and then transmitted by the print server.

According to the present exemplary embodiment, even if the MFP 101 receives the print data without an image orientation specification or print data with a wrong image orientation specification, the CPU 111 can determine the image orientation information based on the post-processing settings with a position specification and reflect the information to the print data. Therefore, when previewing the reserved print data illustrated in FIGS. 7, 8A, 8B, 8C, and 8D, or when setting or changing the print data, the print settings can be prevented from being changed or previewed based on an image orientation not intended by the user. This enables improving the user's convenience. The CPU 111 can determine the image orientation only when the print data generation source is a print service of a predetermined type which generates print data not including the image orientation or print data including the incorrect image orientation. Therefore, in the case of print data entered from a printer driver designed to use each individual printing apparatus, the CPU 111 is able to perform processing without changing the image orientation included in the print data.

In the first exemplary embodiment, a process for determining the image orientation based on the binding processing settings with a position specification has been described. In a second exemplary embodiment, a process for determining the binding edge when performing the post-processing based on the post-processing settings with a position specification will be described in addition to the process according to the first exemplary embodiment. Further, in the second exemplary embodiment, a process for determining the position where the post-processing without a position specification is to be performed based on the binding processing settings with a position specification will be described in addition to the process according to the first exemplary embodiment.

The hardware configuration of the apparatus according to the second exemplary embodiment is similar to that according to the first exemplary embodiment. For similar configuration to that according to the first exemplary embodiment, detailed descriptions thereof will be omitted.

First, print data generated by a general-purpose print service provided by the information processing apparatus will be described below. As described in the first exemplary embodiment, the print properties of the print data generated by the general-purpose print service are not necessarily easy to process for the printing apparatus. For example, print data in which all the print properties required for the printing apparatus are correctly described may not be generated. On the device vendor side, there may be generated print data including print property settings with which the position or direction of the post-processing cannot be uniquely determined. Conventionally, if the printing apparatus performs printing based on such print data, the printing apparatus may possibly output a sheet on which the post-processing is performed at a position not intended by the user or may possibly abnormally end the print processing based on the print data.

A specific example will be described below with reference to FIG. 5B. A print data sample 3 is an example of print data generated when a setting (hereinafter referred to as a print setting sample 3) is made, via the setting screen, to print a landscape image on A4 size (210×297) sheets, form punch holes on each printed sheet, and bind the printed sheets at one position thereon. In this case, printing on A4 size (210×297) sheets and binding at the bottom right corner as a sheet-based binding position are set as print properties in the print data. Further, forming punch holes on a sheet is also specified. However, neither the position where punching is to be performed nor the number of punch holes is explicitly specified. When a specification for turning ON punching is received via the setting screen as indicated by the print data sample 3, the print property only with a punching specification is set.

When such print data is received, it is necessary to set a punching position on the side of the MFP 101.

Although the position where the sheet-based binding processing is to be performed is specified, the binding edge (also referred to as a binding direction) is explicitly set in none of the print data samples 1 to 3.

Methods for binding a print product include left binding, right binding, top binding, and bottom binding. Left binding refers to binding at the left side when the top of the image is upwardly positioned. When performing left binding, the MFP 101 needs to perform printing so that a page is turned from right to left. Right binding refers to binding at the right side when the top of the image is upwardly positioned. When performing right binding, the MFP 101 needs to perform printing so that a page is turned from left to right. Therefore, to perform left or right binding, the MFP 101 needs to perform printing so that the top of the front surface is identical to the top of the rear surface of the print product. Top binding refers to binding at the top side when the top of the image is upwardly positioned. When performing top binding, the MFP 101 needs to perform printing so that a page is turned from the bottom upward. Top binding refer to binding at the bottom side when the top of the image is upwardly positioned. When performing bottom binding, the MFP 101 needs to perform printing so that a page is turned from the top downward. Therefore, when performing top or right binding, the MFP 101 needs to rotate the orientation by 180 degrees between printing on the front and the rear surfaces of the print product.

Thus, when performing two-sided printing based on the print data, not only information about the image orientation but also information about the binding edge must be known.

The present exemplary embodiment will be described below centering on a process for suitably determining the binding edge based on the position where the binding processing is to be performed. The following example is based on the premise that a general-purpose print service sets the binding position where the binding processing is to be performed in the print data on the assumption that left binding should be performed when the print product is viewed from the cover.

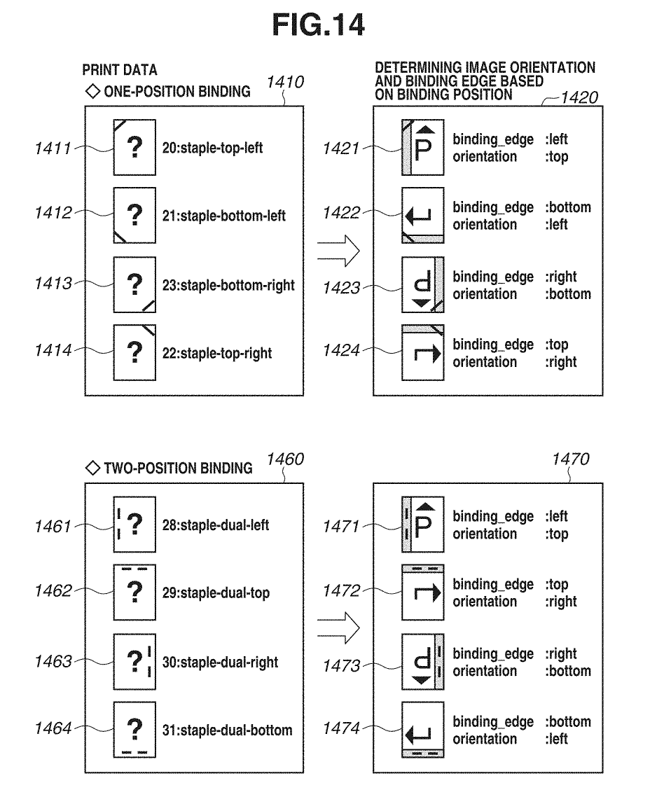

FIG. 14 is a diagram illustrating an example of processing for determining the binding edge. FIG. 14 illustrates a process for determining the binding edge of an image based on the print properties of the binding processing with a position specification as an example of a post-processing setting with a position specification.

The method for determining the image orientation is similar to that according to the first exemplary embodiment, and detailed description thereof will be omitted. Setting the binding edge on the left side with reference to the image orientation enables determining the binding edge for left binding.

The following describes a process for determining the binding edge in a case where binding at any one corner of sheets is specified as a print property of the binding processing (the group 9010). When the binding position of a setting 1411 (top left corner of sheets) is specified, the CPU 111 needs to determine that the left side of sheets is the binding edge as indicated by a setting 1421. When the binding position of a setting 1412 (bottom left corner of sheets) is specified, the CPU 111 needs to determine that the bottom side of sheets is the binding edge as indicated by a setting 1422. When the binding position of a setting 1413 (bottom right corner of sheets) is specified, the CPU 111 needs to determine that the right side of sheets is the binding edge as indicated by a setting 1423. When the binding position of a setting 1414 (top right corner of sheets) is specified, the CPU 111 needs to determine that the top side of sheets is the binding edge as indicated by a setting 1424.

The following describes a process for determining the binding edge in a case where binding at two positions on one side of sheets is specified as a print property of the binding processing (a group 1460). When the binding position of a setting 1461 (two positions at left) is specified, the CPU 111 needs to determine that the left side of sheets is the binding edge as indicated by a setting 1471. When the binding position of a setting 1462 (two positions at top) is specified, the CPU 111 needs to determine that the top side of sheets is the binding edge as indicated by a setting 1472. When the binding position of a setting 1463 (two positions at right) is specified, the CPU 111 needs to determine that the right side of sheets is the binding edge as indicated by the setting 1423. When the binding position of a setting 1464 (two positions at bottom) is specified, the CPU 111 needs to determine that the bottom side of sheets is the binding edge as indicated by a setting 1474.

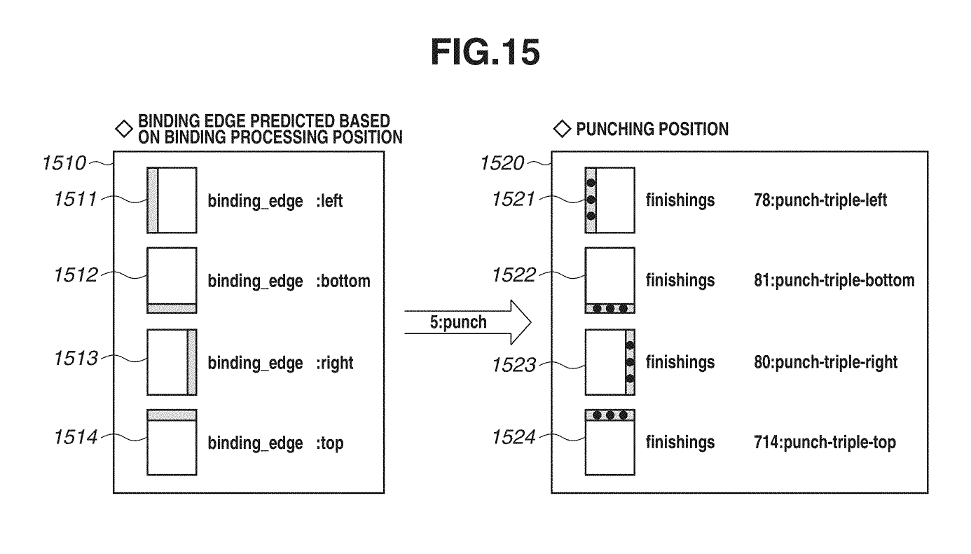

The following describes a process for determining the position where the post-processing without a position specification is to be performed will be described below with reference to FIG. 15. FIG. 15 is a diagram illustrating a method for determining the position where punching is to be performed, without a specification of the position at which the post-processing is to be performed, such determining based instead on the binding edge determined with reference to FIG. 14. The default setting of punching is 3-hole punching.

As illustrated in FIG. 14, the MFP 101 determines the binding edge based on the position where the binding processing for binding sheets is to be performed. The following describes a process for further determining the position where punching is to be performed, based on the binding edge determined based on the binding processing position.

When the binding edge is set on the left side of sheets (a setting 1511), the CPU 111 determines to perform punching also on the left side of each sheet. When the binding edge is set on the bottom side of sheets (a setting 1512), the CPU 111 determines to perform punching also on the bottom side of each sheet. When the binding edge is set on the right side of sheets (a setting 1513), the CPU 111 determines to perform punching also on the right side of each sheet. When the binding edge is set on the top side of sheets (a setting 1514), the CPU 111 determines to perform punching also on the top side of each sheet. The default setting of the number of holes of punching is set in the MFP 101 (for example, three holes as illustrated in FIG. 14). The default settings for punching can be changed by an administrator or the user.

Processing illustrated in FIGS. 14 and 15 enables determining the binding edge when performing the post-processing based on the post-processing settings with a position specification. Processing illustrated in FIGS. 14 and 15 also enables determining the position where the post-processing without an explicit specification of the position, at which the post-processing is to be performed, is to be performed.

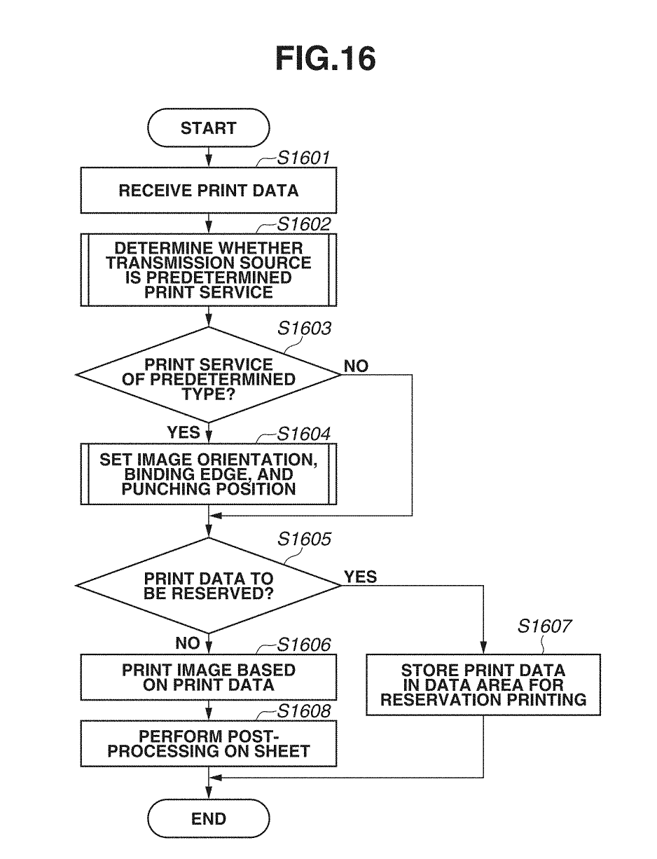

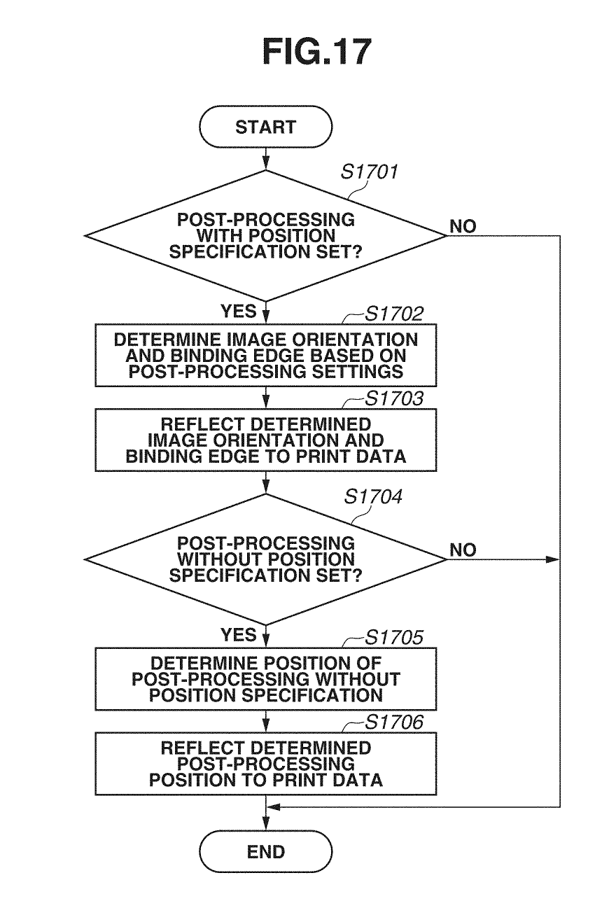

When the MFP 101 receives print data, the MFP 101 determines the binding edge and the punching position according to the binding position for the post-processing with a position specification and then applies the binding edge and the punching position to the print data. This process will be described below with reference to the flowcharts illustrated in FIGS. 16 and 17.

Each operation (step) illustrated in the flowcharts illustrated in FIGS. 16 and 17 is implemented when the CPU 111 of the MFP 101 executes a control program stored in the ROM 112 or the storage 114. FIG. 16 is a flowchart illustrating an operation to be executed instead of the flowchart illustrated in FIG. 10 according to the first exemplary embodiment. The CPU 111 executes the processing in step S1604 instead of the processing in step S1004 according to the first exemplary embodiment. The processing in steps S1601 to S1603 is similar to the processing in steps S1001 to S1003 according to the first exemplary embodiment, and descriptions thereof will be omitted. The processing in steps S1605 to S1608 is similar to the processing in steps S1005 to S1008 according to the first exemplary embodiment, and descriptions thereof will be omitted.

According to the second exemplary embodiment, when the CPU 111 determines that the generation source of the received print data is a print service of a predetermined type (YES in step S1603), the processing proceeds to step S1604.

In step S1604, the CPU 111 performs processing for determining the image orientation and processing for determining the binding edge and the punching position. One example of specific control processing for step 1604 will be described below with reference to the flowchart illustrated in FIG. 17. In step S1701, the CPU 111 determines whether the post-processing with a position specification is set. More specifically, when the print data includes the binding processing settings with a binding position specification as described in the lines 20 to 23 and 28 to 31 illustrated in FIG. 4, the CPU 111 determines that the post-processing with a position specification is set (YES in step S1701), and the processing proceeds to step S1702. On the other hand, when the print data includes the binding processing settings without a position specification or when the print data does not include the binding processing settings, the CPU 111 does not determine the image orientation (NO in step S1701), and the processing proceeds to step S1605. When the CPU 111 does not determine the image orientation, the CPU 111 will perform print processing assuming that the image orientation is the default orientation (more specifically, the upper side of the image included in the print data is the top of the image). When the CPU 111 does not determine the image orientation, the CPU 111 will perform the post-processing without a position specification based on the default settings for the post-processing. The default settings for the post-processing are assumed to have been preset by the user or an administrator via the operation unit 116.

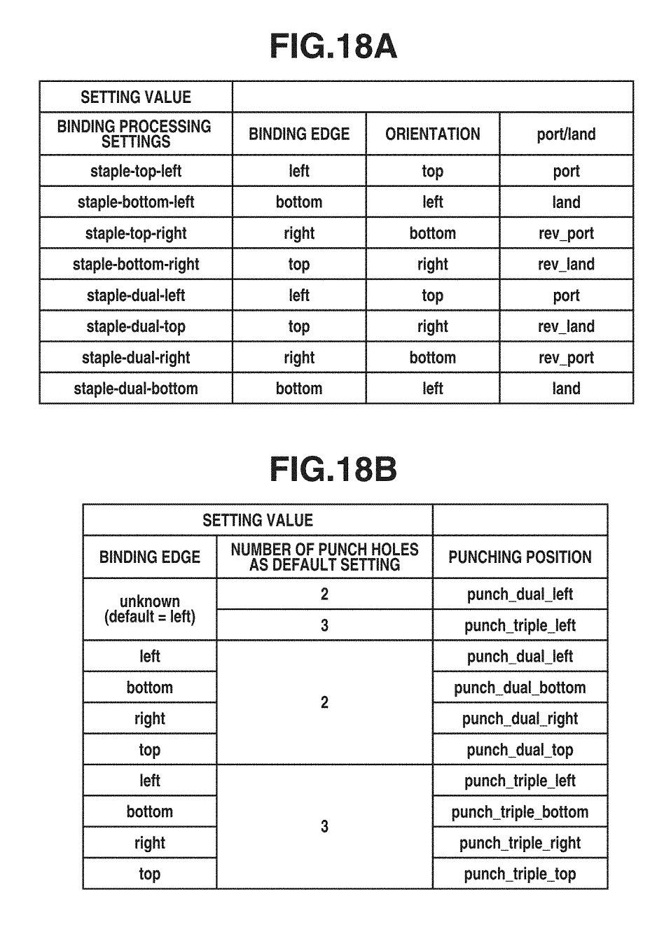

In step S1702, the CPU 111 determines the image orientation and the binding edge based on the post-processing settings. First, the CPU 111 acquires the post-processing setting values included in the print data. The CPU 111 also performs a search in condition tables stored in the storage 114 using the acquired post-processing settings as a search condition to determine the image orientation and the binding edge. FIGS. 18A and 18B are examples of condition tables stored in the storage 114. FIG. 18A is a condition table for determining the image orientation and the binding edge. Although, in the present exemplary embodiment, the image orientation and the binding edge are determined based on the post-processing setting values with a position specification by using the condition tables, the determination method is not limited thereto. For example, the CPU 111 may determine the image orientation and the binding edge by executing a program which describes conditional branches for determining the image orientation and the binding edge described above with reference to FIG. 14.

In step S1703, the CPU 111 applies the image orientation and the binding edge determined in step S1702 to the print data, and the processing proceeds to step S1704.

In step S1704, the CPU 111 determines whether the post-processing without a position specification is set. More specifically, when punching is set without an explicit punching position specification as described in the line 5 illustrated in FIG. 4, the CPU 111 determines that the post-processing without a position specification is set (YES in step S1704), and the processing proceeds to step S1705. On the other hand, when the CPU 111 determines that the post-processing without a position specification is not set (NO in step S1704), the processing proceeds to step S1605.

In step S1705, the CPU 111 determines the position where the post-processing without a position specification is to be performed based on the binding edge. The CPU 111 acquires the binding edge setting determined in step S1702. The CPU 111 also acquires the setting value regarding the default number of punch holes stored in the storage 114 of the MFP 101. Then, the CPU 111 performs a search in a second condition table stored in the storage 114 using the acquired setting values as a search condition to determine the punching position. In this case, the CPU 111 also determines the number of holes to be formed in punching.

FIG. 18B is the second condition table for determining the punching position and the number of punch holes. Although, in the present exemplary embodiment, the punching position and the number of punch holes are determined by using condition tables, the determination method is not limited thereto. For example, the CPU 111 may determine the punching position and the number of punch holes by executing a determination program which describes conditional branches for determining the punching position and the number of punch holes described above with reference to FIG. 14.

In step S1706, the CPU 111 applies the position where the post-processing is to be performed and the number of punch holes determined in step S1705 to the print data, and the control processing of step 1604 concludes, and processing proceeds to step S1605.

Although the present exemplary embodiment is described taking the MFP 101, which includes the printing unit 120, as an example of the print control apparatus, the present exemplary embodiment is not limited thereto. The present exemplary embodiment is also applicable to a print server for transmitting print data to a printing apparatus, for example.

In this case, the print server receives print data from an external apparatus and performs the processing in steps S1601 to S1604 on the received print data. Instead of the processing in step S1605, the CPU 111 needs to transmit to the printing apparatus the print data to which changes based on the post-processing settings obtained in step S1604 are applied. More specifically, the print data received from the external terminal will be suitably converted into print properties convenient for the printing apparatus and then transmitted by the print server.

Although, in the present exemplary embodiment, the binding processing with an explicit binding position specification is described as the post-processing with a position specification, and the punching without an explicit punching position specification is described as post-processing without a position specification, the post-processing is not limited thereto.

The binding edge needs to be determined based at least on first post-processing with an explicit position specification. For the print data including both the first post-processing with an explicit position specification and the second post-processing without an explicit position specification, the CPU 111 needs to determine the position where the second post-processing is to be performed based on the position of the first post-processing.

As described above, according to the present exemplary embodiment, the binding edge to be used at the time of the post-processing can be determined based on the position of the first post-processing with an explicit binding position specification. Therefore, when two-sided printing is specified, the binding processing can be performed based on the binding edge that would have been assumed when generating print data. Further, the position where the second post-processing without an explicit position specification is to be performed can be determined based on the position of the first post-processing with an explicit position specification. Therefore, the second post-processing can be performed at the position that would have been assumed by the user at the time of print setting.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to various embodiments, it is possible to suitably determine an image property not included in the print data.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-249068, filed Dec. 21, 2015, which is hereby incorporated by reference herein in its entirety.

What is claimed is:

1. A print control apparatus comprising:
a memory device that stores a set of instructions; and
at least one processor that executes the instructions for performing operations comprising:
receiving print data transmitted from an information processing apparatus; and
determining an orientation of an image in the print data based on information specified in the print data, the information indicating a position of post-processing to be performed on a sheet on which an image has been printed based on the print data.

2. The print control apparatus according to claim 1, wherein the instructions further include an instruction for displaying, upon condition that an image to be printed based on the received print data is displayed as a preview image, the image so that a top of the image is upwardly positioned based on the determined orientation of the image.

3. The print control apparatus according to claim 1, wherein the instructions further include an instruction for determining, based on the determined orientation of the image, a binding edge to be set when printing the image on a sheet.

4. The print control apparatus according to claim 1, wherein the instructions further include an instruction for determining, upon condition that first post-processing and second post-processing to be performed on the sheet on which the image has been printed are set in the received print data, and that a position of the first post-processing is specified and a position of the second post-processing is not specified in the received print data, a position where the second post-processing is to be performed, based on the determined orientation of the image.

5. The print control apparatus according to claim 1, wherein the first post-processing is binding processing for binding sheets and the second post-processing is punching for forming punch holes on a sheet.

6. The print control apparatus according to claim 4, further comprising:
a printer device; and
a post-processing device capable of performing at least the first post-processing and the second post-processing on a sheet on which an image has been printed by the printer device,
wherein the instructions further include instructions for:
controlling the printer device to print an image on a sheet; and
controlling, upon condition that the first post-processing and the second post-processing are set in the print data, printing by the printer device and post-processing by the post-processing device so that the second post-processing is performed at the determined position on a print product to be output based on the print data.

7. The print control apparatus according to claim 1, wherein the instructions further include an instruction for setting, upon condition that a generation source of the received print data is a service of a predetermined type, the determined orientation as a property of the print data.

8. The print control apparatus according to claim 7, wherein the instructions further include an instruction for determining, upon condition that the print data is transmitted by using an Internet Printing Protocol (IPP) and that a format of the print data is a PWG-RASTER format, the generation source of the print data as the service of the predetermined type.

9. The print control apparatus according to claim 7, wherein the instructions further include an instruction for transmitting the print data including the set property to an external printing apparatus.

10. A print control method executed by a processor, the method comprising:
receiving print data; and
determining an orientation of an image in the print data based on information specified in the print data, the information indicating a position of post-processing to be performed on a sheet on which an image has been printed based on the print data.

11. A non-transitory computer-readable storage medium storing a program for causing a computer to execute a print control method to be performed by a print control apparatus having a storage area, the method comprising:
receiving print data; and
determining an orientation of an image in the print data based on information specified in the print data, the information indicating a position of post-processing to be performed on a sheet on which an image has been printed based on the print data.

12. A print control apparatus comprising:
at least one processor; and
a memory device that stores a set of instructions for performing operations comprising:
receiving print data transmitted from an information processing apparatus; and
determining, upon condition that first post-processing and second post-processing to be performed on a sheet on which an image has been printed are set in the received print data, and that a position of the first post-processing is specified and a position of the second post-processing is not specified in the print data, a position where the second post-processing is to be performed, based on a position where the first post-processing is to be performed.

13. The print control apparatus according to claim 12, wherein the instructions further include an instruction for setting, upon condition that a generation source of the print data is a service of a predetermined type, the determined position of the second post-processing as a property of the print data.

14. The print control apparatus according to claim 13, wherein the instructions further include an instruction for determining, upon condition that the print data is transmitted by using an Internet Printing Protocol (IPP) and that a format of the print data is a PWG-RASTER format, the generation source of the print data as the service of the predetermined type.
